(19) United States
(12) Patent Application Publication
(10) Pub. No.: US 2024/0412307 A1
(43) Pub. Date: Dec. 12, 2024

(54) HANDOVER-TAKEOVER ACTIVITY FOR AN OPERATION SHIFT

(71) Applicant: HONEYWELL INTERNATIONAL INC., Charlotte, NC (US)

(72) Inventors: Vignesh S, Erode (IN); Rajapriyan Thambidurai, Bangalore (IN); Arun Ramesh, Puducherry (IN)

(21) Appl. No.: 18/206,650

(22) Filed: Jun. 7, 2023

(51) Int. Cl. G06Q 50/16

(52) U.S. Cl. CPC G06Q 50/163

(57) ABSTRACT

Techniques for performing Handover-Takeover (HOTO) activity corresponding to an operation shift are described. In an example implementation, an initiation request to initiate the HOTO activity corresponding to an operation shift are received, where the initiation request is received from a first user initiating handover of the operation shift, and the initiation request includes credentials of the first user. Thereafter, credentials of a second user taking over the operation shift from the first user are received. The credentials of the second user are then compared with the credentials of the first user. One of the HOTO activity and a self-takeover activity is then performed based on the comparing of the credentials of the second user with the credentials of the first user.

### BACKGROUND

Facilities are made to run continuously for longer durations to increase production and reduce costs involved in halting and resuming operations in such facilities. For instance, oil refineries are made to run for longer durations as stopping and resuming such refineries frequently can prove to be cost as well as labour intensive process. Similarly, iron and steel factories are made to run for longer durations to optimize costs and labour involved in stopping and resuming the operations. The high costs associated with halting and resuming operations in such facilities can be attributed to utilization of heavy and complex machinery which is both difficult to start, operate, and shut down. To ensure continuous operability of such facilities, various operators are employed who are tasked with handling operations of the machinery being utilized in such facilities. Since such facilities are made to run continuously, the operators work in various operation shifts to handle operations of the machinery.

### SUMMARY

In an example, a method for performing Handover-Takeover (HOTO) activity corresponding to an operation shift is described. In operation, an initiation request to initiate the HOTO activity corresponding to an operation shift are received, where the initiation request is received from a first user initiating handover of the operation shift, and the initiation request includes credentials of the first user. Thereafter, credentials of a second user taking over the operation shift from the first user are received. The credentials of the second user are then compared with the credentials of the first user. One of the HOTO activity and a self-takeover activity is then performed based on the comparing of the credentials of the second user with the credentials of the first user.

In another example, an operations management server for facilitating performing of Handover-Takeover (HOTO) activity corresponding to an operation shift is described. The operations management server comprises a communication engine to receive a request for submission of HOTO summary associated with a Handover-Takeover (HOTO) activity corresponding to an operation shift, where the HOTO summary is indicative of HOTO information corresponding to the operation shift and time consumed in performing of the HOTO activity. The operations management server further comprises an assessment engine coupled to the communication engine The assessment engine is to ascertain an operation shift report corresponding to the operation shift to be in a submitted state at an operations management server. Further, the assessment engine is to determine submission of the HOTO summary to be allowed after submission of the operation shift report to the operations management server. Moreover, the operations management server comprises a determination engine coupled to the assessment engine to allow submission of the HOTO summary based on the determining.

In yet another example, a non-transitory computer readable medium for facilitating performing of Handover-Takeover (HOTO) activity corresponding to an operation shift is described. The non-transitory computer readable medium comprises computer-readable instructions that when executed cause a processing resource of a computing device to receive request for submission of a HOTO summary associated with a Handover-Takeover (HOTO) activity corresponding to an operation shift, along with an operation shift report corresponding to the operation shift, where the operation shift report is indicative of operation details associated with the operation shift. The instructions further cause the processing resource to ascertain an operation shift report corresponding to the operation shift to be in a non-submitted state at an operations management server. Further, the computer-readable instructions cause the processing resource to allow submission of the HOTO summary and the operation shift report based on the ascertaining.

### BRIEF DESCRIPTION OF DRAWINGS

FIG. 1 illustrates a computing environment for performing HOTO activity corresponding to an operation shift, in accordance with an example of the present subject matter,

FIG. 2 illustrates the computing environment for performing the HOTO activity corresponding to the operation shift, in accordance with another example of the present subject matter,

FIG. 3 illustrates a client device for performing the HOTO activity corresponding to the operation shift, in accordance with another example of the present subject matter,

FIG. 4 illustrates an operations management server for facilitating performing of the HOTO activity corresponding to the operation shift, in accordance with another example of the present subject matter,

FIG. 5 illustrates a method for performing the HOTO activity corresponding to the operation shift, in accordance with an example of the present subject matter,

FIG. 6 illustrates another method for performing the HOTO activity corresponding to the operation shift, in accordance with an example of the present subject matter,

FIG. 7 illustrates a method for facilitating performing of the HOTO activity corresponding to the operation shift, in accordance with an example of the present subject matter,

FIG. 8 illustrates another method for facilitating performance of the HOTO activity corresponding to the operation shift, in accordance with an example of the present subject matter,

FIG. 9 illustrates yet another method for facilitating performing of the HOTO activity corresponding to the operation shift, in accordance with an example of the present subject matter, and

FIG. 10 illustrates a non-transitory computer-readable medium for facilitating performing of the HOTO activity corresponding to the operation shift, in accordance with an example of the present subject matter.

Throughout the drawings, identical reference numbers designate similar, but not necessarily identical, elements. The drawings provide examples and/or implementations consistent with the description; however, the description is not limited to the examples and/or implementations provided in the drawings.

### DETAILED DESCRIPTION

During an operation shift, an operator is responsible for various tasks, such as operating the machinery, monitoring various operational parameters associated the machinery, and altering the various operational parameters to ensure that the machinery keeps operating efficiently. The operator is further required to record details related to such tasks and maintain an operation shift report based on such details. When the operation shift ends, the operation shift report corresponding to the operation shift is typically passed on to another operator who takes over the responsibility of the various tasks to be performed during a subsequent shift. Since the operation shifts typically last for standard working hours, the details included in the operation shift report can be substantial.

Accordingly, when an operation shift changes, the operator may explicitly communicate some or all information included in the operation shift report to the other operator, where the communicated information may be crucial with respect to the operations of the facility. The communicated information may or may not be accompanied by the operation shift report. If required, the operation shift report may be referred to by the other operator for identification of any further details related to the communicated information.

Such a process of transfer of the communicated information along with the operation shift report is generally referred to as a Handover-Takeover (HOTO) activity. During the HOTO activity, an outgoing operator hands over the operation shift report to an incoming operator. Along with the operation shift report, the outgoing operator may also communicate HOTO information, i.e., the information crucial with respect to the operations of the machinery in the facility, to the incoming operator.

In many situations, the operation shift report and the HOTO information corresponding to various such operation shifts is recorded electronically, such that the HOTO activities may be tracked and analysed for taking decisions to improve efficiency associated with the overall operating efficiency of the facility.

There are instances when the HOTO activity may not be performed efficiently. The HOTO activity may not be performed efficiently due to multiple reasons. For instance, in an example, the HOTO information may not be recorded effectively due to less or no overlap time between arrival of the incoming operator and departure of the outgoing operator. Further, there may be a situation when an operator may try resubmitting the HOTO information or the operation shift report after the HOTO activity has been performed. In such a situation, it may become difficult to ascertain the credibility of the HOTO activity, thereby reducing the efficiency associated with the HOTO activity. Moreover, there may be instances when the HOTO activity may not be performed as the outgoing operator may continue for another operation shift. In such a situation, the outgoing operator may still record the HOTO information and the operation shift report owing to workflow related constraints. Thus, the HOTO information and the operation shift report may be recorded even in situations where the HOTO activity is not performed.

According to examples of the present subject matter, techniques for efficiently performing HOTO activity corresponding to an operation shift are described.

In an example implementation, an initiation request to initiate the HOTO activity corresponding to the operation shift may be received. The initiation request may be received from a first user initiating handover of the operation shift and may include credentials of the first user. Thereafter, credentials of a second user taking over the operation shift from the first user may be received. In an example, the credentials of the second user may be validated to ascertain the authenticity of the second user for taking over the shift from the first user. The credentials of the second user may then be compared with the credentials of the first user. Based on the comparing of the credentials of the second user with the credentials of the first user, one of a HOTO activity and a self-takeover activity may be performed.

In an example, when the second user is determined to be different from the first user based on comparing the credentials of the second user with the credentials of the first user, the HOTO activity may be performed. In such a situation, a HOTO timer may be initiated based on determining the second user to be different from the first user. Thereafter, HOTO information corresponding to the operation shift may be received from the first user. The HOTO timer may be stopped upon receipt of the HOTO information. A HOTO summary corresponding to the operation shift may then be generated, where the HOTO summary is indicative of the HOTO information and time consumed in the performing of the HOTO activity. The HOTO summary may then be transmitted to an operations management server. In an example, the HOTO summary may be accompanied by an operation shift report corresponding to the operation shift, where the operation shift report is prepared by the first user and is indicative of the operation details associated with the operation shift.

In another example, when the second user is determined to be same as the first user based on comparing the credentials of the second user with the credentials of the first user, the self-takeover activity may be performed. In such a situation, takeover information corresponding to the operation shift may be received from the first user. A takeover summary corresponding to the operation shift may then be generated, where the take summary is indicative of the takeover information.

Selectively performing the HOTO activity in scenarios when the operation shift is being handed over from one user to another user facilitates optimization in utilization of resources involved in recording the time consumed in performing the HOTO activity and submission of the HOTO information, thereby improving the overall efficiency involved in performing the HOTO activity.

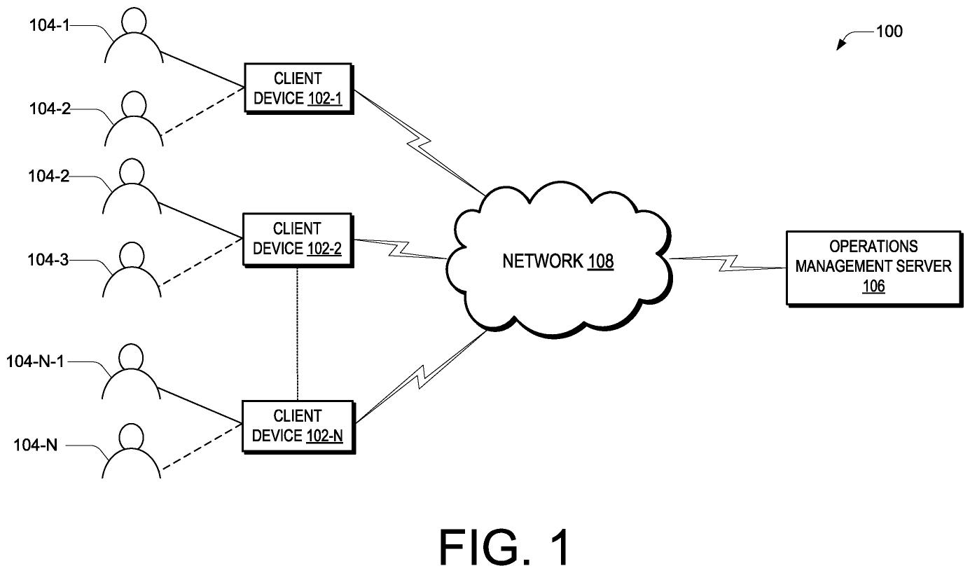

The above techniques are further described with reference to FIGS. 1 to 10. It would be noted that the description and the FIGS. merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates a computing environment 100 for performing HOTO activity corresponding to an operation shift, in accordance with an example of the present subject matter. The computing environment 100 includes a plurality of client devices 102-1, 102-2, . . . , 102-N that may be utilized by a plurality of users 104-1, 104-2, . . . , 104-N to submit various operational details during the operation shift. Examples of the plurality of client devices 102-1, 102-2, . . . , 102-N may include laptops, desktops, smartphones, tablets, and personal digital assistants. For the ease of reference, the plurality of client devices 102-1, 102-2, . . . , 102-N and the plurality of users 104-1, 104-2, . . . , 104-N have been respectively referred to as the plurality of client devices 102 and plurality of users 104, hereinafter.

The computing environment 100 may further include an operations management server 106 coupled to the plurality of client devices 102. The operations management server 106 may either be a standalone computer or a combination of multiple computing devices operating together in a distributed computing environment. Examples of the operations management server 106 may include, but are not limited to, laptops, desktops, tower servers, rack servers, blade servers, and mainframes.

The plurality of client devices 102 may be coupled to the operations management server 106 through a network 108. The plurality of client devices 102 may be communicatively coupled to the operations management server 106 either through a direct communication link, or through multiple communication links of the network 108.

The network 108 may be a wireless or a wired network, or a combination thereof. The network 108 can be a collection of individual networks, interconnected with each other and functioning as a single large network. Examples of such individual networks include, but are not limited to, Global System for Mobile communication (GSM) network, Universal Mobile Telecommunications System (UMTS) network, Long Term Evolution (LTE) network, 5th Generation New Radio network, personal communications service (PCS) network, Time-division multiple access (TDMA) network, Code-Division Multiple Access (CDMA) network, next-generation network (NGN), public switched telephone network (PSTN), and Integrated Services Digital Network (ISDN). Depending on the terminology, the communication network includes various network entities, such as gateways and routers; however, such details have been omitted to maintain the brevity of the description.

In an example implementation, when the operation shift is about to end, a client device 102-1, from the plurality of devices 102, may receive an initiation request to initiate a HOTO activity. In an example, the client device 102-1 may receive the initiation request from a first user, such as a user 104-1, from amongst the plurality of users 104. In the example, the client device 102-1 may include an interface (not shown) for facilitating reception of the initiation request from the user 104-1. For instance, the client device 102-1, in an example, may have a touch screen interface for facilitating reception of the initiation request from the user 104-1. The client device 102-1, in another example, may include physical buttons for facilitating reception of the initiation request from the user 104-1.

In an example, the initiation request may include credentials of the first user 104-1. The client device 102-1 may then authenticate the first user 104-1 based on validation of the credentials of the first user 104-1. Based on the authentication of the first user 104-1, the client device 102-1 may generate a prompt for receiving credentials of a second user, e.g., a user 104-2, designated for takeover of the operation shift from the first user 104-1.

The client device 102-1 may then receive credentials of the second user 104-2. In an example, the client device 102-1 may then authenticate the second user 104-2 based on validation of the credentials of the second user 104-2. Once authenticated, the client device 102-1 may compare the credentials of the second user 104-2 with the credentials of the first user 104-1. Based on the comparing, the client device 102-1 may initiate one of the HOTO activity and a self-takeover activity.

In an example, when the client device 102-1 determines the second user 104-2 to be different from the first user 104-1 based on comparing the credentials of the second user 104-2 with the credentials of the first user 104-1, the client device 102-1 may initiate the HOTO activity. Once the HOTO activity is completed, the client device 102-1 may generate a HOTO summary, where the HOTO summary may be indicative of time consumed in performing the HOTO activity and information exchanged during the HOTO activity, i.e., HOTO information. The client device 102-1 may then transmit the HOTO summary to the operations management server 106.

In another example, when the client device 102-1 determines the second user to be same as the first user based on the comparing the credentials of the second user 104-2 with the credentials of the first user 104-1, the client device 102-1 may initiate the self-takeover activity. Once the self-takeover activity is completed, the client device 102-1 may generate a takeover summary. The client device 102-1 may then transmit the takeover summary to the operations management server 106.

In an example implementation, the operations management server 106 may receive a request for submission of the HOTO summary or the takeover summary from the client device 102-1. On receiving of the request for submission of the HOTO summary or the takeover summary, the operations management server 106 may detect if an operation shift report corresponding to the operation shift has already been submitted. The operation shift report is usually prepared by the first user during the operation shift and is indicative of the operation details associated with the operation shift. The operations management server 106 may allow submission of the HOTO summary or the takeover summary based on a state of submission of the operation shift report. In an example, the state of submission of the operation shift report may be determined by ascertaining whether the operation shift report has been successfully stored at the operations management server 106 or not. For instance, if it is determined that the operation shift report has been successfully stored at the operations management server 106, the operation shift report is said to be in a submitted state. On the other hand, if it is determined that the operation shift report is yet to be stored at the operations management server 106, the operation shift report is said to be in a non-submitted state.

In an example, when the operations management server 106 determines the operation shift report to be in the submitted state, the operations management server 106 may determine if the submission of the HOTO summary or the takeover summary is allowed after submission of the operation shift report. If the operations management server 106 determines that the submission of the HOTO summary or the takeover summary is allowed after submission of the operation shift report, the operations management server 106 may allow the HOTO summary or the takeover summary to be submitted, i.e., the operations management server 106 may allow the HOTO summary or the takeover summary to be stored thereon.

On the other hand, if the operations management server 106 determines that the HOTO summary or the takeover summary is not allowed after submission of the operation shift report, the operations management server 106 may not allow the HOTO summary or the takeover summary to be submitted, i.e., i.e., the operations management server 106 may not allow the HOTO summary or the takeover summary to be stored thereon. In such a situation, the operations management server may discard the HOTO summary or the takeover summary received from the client device 102-1.

In another example, when the operations management server 106 determines the operation shift report to be in the non-submitted state, the operations management server 106 may not allow the submission of the HOTO summary or the takeover summary. In the example, the operations management server 106 may transmit an indication for submission of the operation shift report to the client device 102-1. Further, in the example, the operations management server 106 may allow submission of the HOTO summary or the takeover summary after submission of the operation shift report.

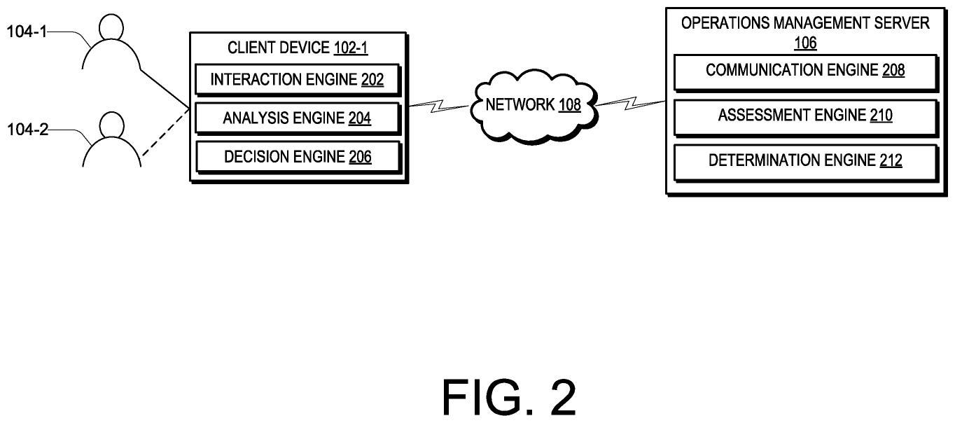

FIG. 2 illustrates the computing environment 100 for performing HOTO activity corresponding to the operation shift, in accordance with another example of the present subject matter. As already described, the computing environment 100 may include the plurality of client devices 102 and the operations management server 106 coupled to the plurality of client devices 102 via the network 108. Further, the plurality of client devices 102 may be utilized by the plurality of users 104 to provide various operational details during the operation shift. For instance, when the plurality of client devices is being utilized at an industrial facility, the plurality of client devices 102 may be utilized by operators for providing details related to the operation of machinery installed at the industrial facility during an operation shift. On the other hand, when the plurality of devices 102 is being utilized at a medical facility, such as a hospital, the plurality of client devices 102 may be utilized by hospital staff for providing details related to medicines administered to various patients being treated at the medical facility during an operation shift. In an example, the various operational details provided by the plurality of users 104, during the operation shift, may be collated to generate the operation shift report.

In an example, the plurality of client devices 102 may also be utilized for performing HOTO activity corresponding to an operation shift, when the operation shift ends. For the sake of explanation, the upcoming example implementations of the present subject matter has been explained with reference to the client device 102-1 from amongst the plurality of client devices 102.

In an example, the client device 102-1 may include an interaction engine 202 that may receive a request for initiation of the HOTO activity for the operation shift. The interaction engine 202 may receive the request for initiation of the HOTO activity from a user, such as the first user 104-1, from the plurality of users 104. In an example, the request for initiation of the HOTO activity may include the credentials of the first user 104-1. On receiving the request for initiation of the HOTO activity, the client device 102 may authorize the first user 104-1 based on validation of the credentials of the first user 104-1.

In an example, once the interaction engine 202 has authorized the first user 104-1, the interaction engine 202 may generate a prompt for receiving credentials of another user, such as the second user 104-2, designated for taking over the operation shift from the first user 104-1. In an example, the interaction engine 202 may generate the prompt on the client device 102-1 if the second user 104-2 is to utilize the client device 102-1 for capturing the various operational details after taking over the operation shift from the first user 104-1. In another example, the interaction engine 202 may generate the prompt on another client device, such as the client device 102-2, if it is determined that the second user 104-2 is to utilize the client device 102-2 for capturing the various operational details after taking over the operation shift from the first user 104-1.

The interaction engine 202 may identify the client device on which the prompt is to be generated in various ways. In an example, the interaction engine 202 may identify the client device on which the prompt is to be generated based on certain predetermined rules. For instance, the interaction engine 202 may identify a client device that is to be utilized during a subsequent shift based on a shift roster and may accordingly generate the prompt on the client device. In another example, the interaction engine 202 may identify the client device that is to be utilized during the subsequent shift based on a user input. The interaction engine 202 may then receive the credentials of the second user 104-2.

The client device 102-1 may further include an analysis engine 204 coupled to the interaction engine 202, where the analysis engine 204 may compare the credentials of the first user 104-1 with the credentials of the second user 104-2. Based on the comparing, the analysis engine 204 may determine if the HOTO activity or self-takeover is to be performed. In an example, when the analysis engine 204 determines the credentials of the first user to different from the credentials of the second user, the analysis engine 204 may initiate the HOTO activity. In another example, when the analysis engine 204 determines the credentials of the first user to same as the credentials of the second user, the analysis engine 204 may initiate the self-takeover activity.

The client device 102-1 may further include a decision engine 206 for performing one of the HOTO activity and the self-takeover activity.

In an example, when the analysis engine 204 determines that the HOTO activity is to be performed, the decision engine 206 may initiate a HOTO timer. In an example, the interaction engine 202 may detect the initiation of the HOTO timer and generate a prompt for receiving HOTO information from the first user 104-1. The HOTO information may be indicative of crucial information related to the operation shift and may include some or all information included in the operation shift report. The interaction engine 202 may then receive the HOTO information from the first user 104-1.

Once the interaction engine 202 has received the HOTO information from the first user 104-1, the interaction engine 202 may receive a completion request to stop the HOTO activity. In the example, the decision engine 206 may stop the timer upon receiving of the completion request. The decision engine 206 may then generate a HOTO summary corresponding to the operation shift, where the HOTO summary is indicative of the HOTO information and time consumed in the performing of the HOTO activity. In an example, the decision engine 206 may subsequently transmit the HOTO summary to the operations management server 106.

In another example, when the analysis engine 204 determines that the self-takeover activity is to be performed, the decision engine 206 may generate a prompt for receiving takeover information from the first user 104-1. Similar to the HOTO information, the takeover information may be indicative of crucial information related to the operation shift and may include some or all information included in the operation shift report. The interaction engine 202 may then receive the takeover information from the first user 104-1.

Once the interaction engine 202 has received the takeover information from the first user 104-1, the interaction engine 202 may generate a takeover summary corresponding to the operation shift, where the takeover summary is indicative of the takeover information. In an example, the decision engine 206 may subsequently transmit the takeover summary to the operations management server 106.

In an example implementation, the operations management server 106 may receive a request for submission of the HOTO summary or the takeover summary. The operations management server 106 may include a communication engine 208 for receiving the request for submission of the HOTO summary or the takeover summary.

The operations management server 106 may further include an assessment engine 210 coupled to the communication engine 208. Upon reception of the HOTO summary or the takeover summary, the assessment engine 210 may determine if the operation shift report for the operation shift has already been submitted. The assessment engine 210 may allow submission of the HOTO summary or the takeover summary based on a state of submission of the operation shift report.

In an example, when the assessment engine 210 determines that the operation shift report is in a submitted state, the assessment engine 210 may determine if the submission of the HOTO summary or the takeover summary is allowed after submission of the operation shift report.

The assessment engine 210 may determine the submission of the HOTO summary or the takeover summary to be allowed after submission of the operation shift report based on policies prescribed by an organisation where the HOTO activity or self-takeover activity is being performed. The policies may be prescribed based on various factors. For instance, in an example, the policies may be prescribed based on an overlap time between arrival of the second user 104-2 and departure of the first user 104-1 while the HOTO activity is being performed. If the nature of activities being performed at a facility entails a shorter overlap time, the organisation may require the first user 104-1 to submit the operation shift report before initiation of the HOTO activity or the self-takeover activity. In such a situation, the submission of the HOTO summary or the takeover summary may be allowed after submission of the operation shift report.

The operations management server 106 may further include a determination engine 212 coupled to the assessment engine 210. If the assessment engine 210 determines that the submission of the HOTO summary or the takeover summary is allowed after submission of the operation shift report, the determination engine 212 may allow the HOTO summary or the takeover summary to be submitted. On the other hand, if the assessment engine 210 determines that the HOTO summary or the takeover summary is not allowed after submission of the operation shift report, the determination engine 212 may not allow the HOTO summary or the takeover summary to be submitted.

In another example, when the assessment engine 210 determines the operation shift report to be in a non-submitted state, the determination engine 212 may not allow the submission of the HOTO summary or the takeover summary. In the example, the communication engine 208 may transmit an indication for submission of the operation shift report to the client device 102-1. Further, in the example, the determination engine 212 may allow submission of the HOTO summary or the takeover summary along with the operation shift report.

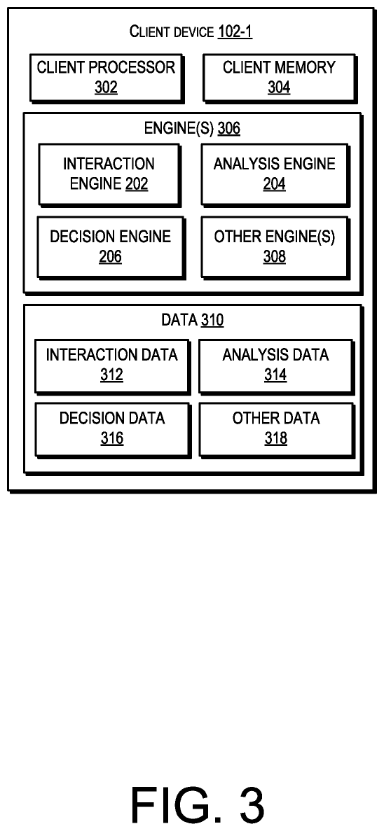

FIG. 3 illustrates the client device 102-1 for performing HOTO activity corresponding to the operation shift, in accordance with an example of the present subject matter. Examples of the client device 102-1 may include laptops, desktops, smartphones, tablets, and personal digital assistants.

The client device 102-1 may include a client processor 302 and a client memory 304 coupled to the client processor 302. The functions of the various elements shown in the FIGS., including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, conventional and/or custom, may also be included.

The client memory 304 may include any computer-readable medium including, for example, volatile memory (e.g., RAM), and/or non-volatile memory (e.g., EPROM, flash memory, etc.).

The client device 102-1 may further include engines 306, where the engines 306 may include the interaction engine 202, the analysis engine 204 coupled to the interaction engine 202, the decision engine 206 coupled to the analysis engine 204, and other engine(s) 308. In an example, the engines 306 may be implemented as a combination of hardware and firmware or software. In examples described herein, such combinations of hardware and firmware may be implemented in several different ways. For example, the firmware for the engine may be processor executable instructions stored on a non-transitory machine-readable storage medium and the hardware for the engine may include a processing resource (for example, implemented as either a single processor or a combination of multiple processors), to execute such instructions.

In the present examples, the machine-readable storage medium may store instructions that, when executed by the processing resource, implement the functionalities of the engine. In such examples, the client device 201-1 may include the machine-readable storage medium storing the instructions and the processing resource to execute the instructions. In other examples of the present subject matter, the machine-readable storage medium may be located at a different location but accessible to the client device 201-1 and the client processor 302.

The client device 201-1 may further include data 310, that serves, amongst other things, as a repository for storing data that may be fetched, processed, received, or generated by the interaction engine 202, the analysis engine 204, the decision engine 206, and the other engine(s) 308. In an example, the data 310 may include interaction data 312, the analysis data 314, the decision data 316, and other data 318. In an example, the data 310 may be stored in the client memory 304.

In an example implementation, the interaction engine 202 may receive various operational details during the operation shift. For instance, when the client device 201-1 is being utilized in an industrial facility, such as an oil refinery, the interaction engine 202 may receive the operational state of various equipment installed in the oil refinery during the operation shift. Similarly, when the client device 201-1 is being utilized in a medical facility, such as a hospital, the interaction engine 202 may receive details related to medicines administered to various patients being treated at the medical facility during an operation shift. The interaction engine 202 may store the operational details received during the operational shift in the interaction data 312.

In an example, interaction engine 202 may fetch the operational details stored in the interaction data 312 and generate an operation shift report corresponding to the operation shift based on the operational details. In the example, the interaction engine 202 may generate the operation shift report when the operation shift is about to end. For instance, the interaction engine 202 may generate the operation shift around ‘5’ minutes before ending of the operation shift. The interaction engine 202 may store the operation shift report in the interaction data 312. The operation shift report may be tagged with credentials of a user who provided the operational details. For instance, if the operational details are provided by the first user 104-1, the operation shift report may be tagged with the credentials of the first user 104-1.

When the operation shift ends, the interaction engine 202 may receive the request for initiation of the HOTO activity. The request for initiation of the HOTO activity may be received from the first user 104-1. On receiving the request for initiation of the HOTO activity, the interaction engine 202 may generate a prompt for receiving the credentials of the first user 104-1. The interaction engine 202 may then receive the credentials of the first user 104-1. In an example, the interaction engine 202 may then authenticate the first user 104-1 based on the validation of the credentials of the first user 104-1. Once the first user 104-1 has been authenticated, the interaction engine 202 may store the credentials of the first user in the interaction data 312.

In an example implementation, once the interaction engine 202 has received the credentials of the first user 104-1, the analysis engine 204 may ascertain the first user 104-1 to be an author of the operation shift report. The analysis engine 204 may ascertain the first user 104-1 to be the author of the operation shift report based on a comparison of the credentials of the first user 104-1 with the credentials tagged with the operation shift report.

When the analysis engine 204 determines the credentials of the first user 104-1 to be different from the credentials tagged with the operation shift report, the decision engine 206 may perform the HOTO activity. In such a situation, the decision engine 206 may initiate the HOTO timer. The interaction engine 202 may then generate a prompt for receiving the HOTO information from the first user. Thereafter, the interaction engine 202 may receive the completion request to stop the HOTO activity. Upon receiving the completion request from, the decision engine 206 may stop the HOTO timer. The decision engine 206 may then generate the HOTO summary corresponding to the operation shift. As already explained, the HOTO summary may be indicative of the HOTO information and time consumed in performing the HOTO activity. The decision engine 206 may then store the HOTO summary corresponding to the operation shift in the decision data 316. In an example, the decision engine 206 may also transmit the HOTO summary corresponding to the operation shift to the operations management server 106.

On the other hand, when the analysis engine 204 determines the credentials of the first user 104-1 to be same as the credentials tagged with the operation shift report, the decision engine 206 may perform the self-takeover activity. In an example, when the analysis engine 204 determines the credentials of the first user 104-1 to be same as the credentials tagged with the operation shift report, the decision engine 206 may generate a prompt for receiving the takeover information from the first user 104-1. The decision engine 206 may then generate the takeover summary corresponding to the operation shift, where the takeover summary is generated based on the takeover information. The decision engine 206 may then store the takeover summary corresponding to the operation shift in the decision data 316. In an example, the decision engine 206 may also transmit the takeover summary corresponding to the operation shift to the operations management server 106.

In another example implementation, once the interaction engine 202 has received the credentials of the first user 104-1, the interaction engine 202 may generate another prompt to receive the credentials of the second user 104-2 taking over the operation shift from the first user 104-1. As already described, the interaction engine 202 may generate the other prompt for receiving the credentials of the second user 104-2 either on the client device 102-1 or another client device from the plurality of client devices 102. The interaction engine 202 may then receive the credentials of the second user 104-2.

The interaction engine 202 may authenticate the second user 104-2 based on the validation of the credentials of the second user 104-2. Once the second user 104-2 has been authenticated, the interaction engine 202 may store the credentials of the second user in the interaction data 312.

The analysis engine 204 may then fetch the credentials of the first user 104-1 and the credentials of the second user 104-2 from the interaction data 312 and perform a comparison of the credentials of the first user 104-1 with the credentials of the second user 104-2. Based on the comparison, the analysis engine 204 may perform one of the HOTO activity or the self-takeover activity. The analysis engine 204 may store the result of the comparison in the analysis data 314.

When the analysis engine 204 determines the credentials of the second user 104-2 to be different from the credentials of the first user 104-1, the decision engine 206 may perform the HOTO activity. In such a situation, the decision engine 206 may initiate the HOTO timer. The interaction engine 202 may then generate a prompt for receiving the HOTO information from the first user.

Thereafter, the interaction engine 202 may receive the completion request to stop the HOTO activity. Upon receiving the completion request from, the decision engine 206 may stop the HOTO timer. The decision engine 206 may then generate the HOTO summary corresponding to the operation shift. As already explained, the HOTO summary may be indicative of the HOTO information and time consumed in performing the HOTO activity. The decision engine 206 may then store the HOTO summary corresponding to the operation shift in the decision data 316. In an example, the decision engine 206 may also transmit the HOTO summary corresponding to the operation shift to the operations management server 106.

On the other hand, when the analysis engine 204 determines the credentials of the second user 104-2 to be same as the credentials of the first user 104-1, the decision engine 206 may perform the self-takeover activity. In an example, when the analysis engine 204 determines the credentials of the second user 104-2 to be same as the credentials of the first user 104-1, the decision engine 206 may generate a prompt for receiving the takeover information from the first user 104-1. The decision engine 206 may then generate the takeover summary corresponding to the operation shift, where the takeover summary is generated based on the takeover information. The decision engine 206 may then store the takeover summary corresponding to the operation shift in the decision data 316. In an example, the decision engine 206 may also transmit the takeover summary corresponding to the operation shift to the operations management server 106.

Selectively performing the HOTO activity in scenarios when the operation shift is being handed over from one user to another user facilitates optimization in utilization of resources involved in recording the time consumed in performing the HOTO activity and submission of the HOTO information, thereby improving the overall efficiency involved in performing the HOTO activity.

In an example, the decision engine 206 may store, in the decision data 316, HOTO summaries and takeover summaries corresponding to a plurality of operation shifts. In the example, the decision engine 206 may analyse the HOTO summaries and the takeover summaries to generate a training dataset. In operation, to generate the training dataset, the decision engine 206 may first analyse the HOTO summaries and the takeover summaries based on an unsupervised machine learning model to form various data clusters. Examples of the unsupervised machine learning model that may be utilized to form the data clusters may include, but are not limited to, K-means clustering, KNN (k-nearest neighbors), Hierarchal clustering, Anomaly detection, Neural Networks, Principle Component Analysis, Independent Component Analysis, Apriori algorithm, and Singular value decomposition. The data clusters may then be analysed and classified to mark the HOTO activities and the self-takeover activities corresponding to the HOTO summaries and the takeover summaries as efficient or inefficient. In an example, the data clusters may be analysed and classified to mark the HOTO activity or the self-takeover activity as efficient or inefficient based on the policies prescribed by the organisation where the HOTO activity or self-takeover activity is being performed.

The decision engine 206 may then train a supervised machine learning model based on the training dataset to classify subsequent HOTO activities and the self-takeover activities as efficient or inefficient. Examples of the supervised machine learning model that may utilized for classification of the subsequent HOTO activities and the self-takeover activities include, but are not limited to, logistic regression, decision tree, random forest, support vector machine, K-Nearest Neighbour (KNN), and Naive Bayes.

In an example, the decision engine 206 may utilize the machine learning model to classify the HOTO summary corresponding to the operation shift as one of efficient or inefficient. The decision engine 206 may subsequently transmit a classification of the HOTO activity or the self-takeover activity to the operations management server 106.

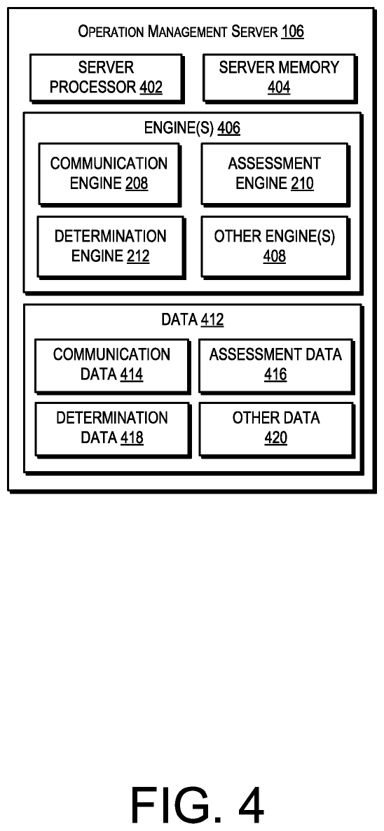

FIG. 4 illustrates the operations management server 106 for facilitating performing of the HOTO activity, in accordance with an example of the present subject matter. As already described, examples of the operations management server 106 may include, but are not limited to, laptops, desktops, tower servers, rack servers, blade servers, and mainframes.

The operations management server 106 may include a server processor 402 and a server memory 404 coupled to the server processor 402. The functions of the various elements shown in the FIGS., including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, conventional and/or custom, may also be included.

The memory 404 may include any computer-readable medium including, for example, volatile memory (e.g., RAM), and/or non-volatile memory (e.g., EPROM, flash memory, etc.).

The operations management server 106 may further include engines 406, where the engines 406 may include the communication engine 208, the assessment engine 210 coupled to the communication engine 208, the determination engine 212 coupled to the assessment engine 210, and other engine(s) 408. In an example, the engines 406 may be implemented as a combination of hardware and firmware or software. In examples described herein, such combinations of hardware and firmware may be implemented in several different ways. For example, the firmware for the engine may be processor executable instructions stored on a non-transitory machine-readable storage medium and the hardware for the engine may include a processing resource (for example, implemented as either a single processor or a combination of multiple processors), to execute such instructions.

In the present examples, the machine-readable storage medium may store instructions that, when executed by the processing resource, implement the functionalities of the engine. In such examples, the operations management server 106 may include the machine-readable storage medium storing the instructions and the processing resource to execute the instructions. In other examples of the present subject matter, the machine-readable storage medium may be located at a different location but accessible to the operations management server 106 and the server processor 402.

The operations management server 106 may further include data 412, that serves, amongst other things, as a repository for storing data that may be fetched, processed, received, or generated by the communication engine 208, the assessment engine 210, the determination engine 212, and other engine(s) 408. In an example, the data 412 may include communication data 414, assessment data 416, the determination data 418, and other data 420. In an example, the data 412 may be stored in the client memory 404.

In an example implementation, the communication engine 208 may receive a request for submission of the HOTO summary or the takeover summary corresponding to the operation shift. As already explained, the HOTO summary is indicative of HOTO information corresponding to the operation shift and time consumed in the performing of the HOTO activity. Further, the takeover summary is indicative of the takeover information corresponding to the operation shift.

Upon reception of the HOTO summary or the takeover summary, the assessment engine 210 may determine if the operation shift report for the operation shift has already been submitted. In an example, the operations management server 106 may store, in the assessment data 416, a plurality of operation shift reports associated with various operation shifts, where each of the plurality of the operation shift reports are stored with the corresponding operation shift identification associated with the operation shift. In the example, upon reception of the HOTO summary or the takeover summary, the assessment engine 210 may check if the assessment data 416 includes the operation shift report corresponding to the operation shift based on the operation shift identification associated with the operation shift report. The assessment engine 210 may allow submission of the HOTO summary or the takeover summary based on a state of submission of the operation shift report.

In an example, when the assessment engine 210 determines that the operation shift report is in a submitted state, the assessment engine 210 may determine if the submission of the HOTO summary or the takeover summary is allowed after submission of the operation shift report.

The assessment engine 210 may determine the submission of the HOTO summary or the takeover summary to be allowed after submission of the operation shift report based on policies prescribed by an organisation where the HOTO activity or self-takeover activity is being performed. As already explained, the policies may be prescribed based on various factors. For instance, in an example, the policies may be prescribed based on an overlap time between arrival of the second user 104-2 and departure of the first user 104-1 while the HOTO activity is being performed. If the nature of activities being performed at a facility entails a shorter overlap time, the organisation may require the first user 104-1 to submit the operation shift report before initiation of the HOTO activity or the self-takeover activity. In such a situation, the submission of the HOTO summary or the takeover summary may be allowed after submission of the operation shift report.

In an example, if the assessment engine 210 determines that the submission of the HOTO summary or the takeover summary is allowed after submission of the operation shift report, the determination engine 212 may determine if the HOTO activity or the self-takeover activity being performed is a first instance of the HOTO activity or the self-takeover activity. In the example, along with the plurality of operation shift reports associated with various operation shifts, the operations management server 106 may also store in the assessment data 416, a plurality of HOTO summaries or takeover summaries associated with various operation shifts. In operation, to determine if the HOTO activity or the self-takeover activity being performed is the first instance of the HOTO activity or the self-takeover activity, the determination engine 212 may check if the assessment data 416 includes the HOTO summary or the takeover summary corresponding to the operation shift based on the operation shift identification associated with the operation shift report.

If the determination engine 212 determines that the HOTO activity or the self-takeover activity being performed is indeed the first instance of the HOTO activity or the self-takeover activity, the determination engine 212 allow the HOTO summary or the takeover summary to be submitted. In such a situation, the determination engine 212 may store the HOTO summary or the takeover summary in the determination data 418.

In an example, once the HOTO summary or the takeover summary has been received, the determination engine 212 may lock the HOTO summary or the takeover summary for preventing re-submission of HOTO summaries or takeover summaries corresponding to further instances of the HOTO activity or the self-takeover activity. In the example, the determination engine 212 may mark a flag against the HOTO summary and the takeover summary stored in the assessment data 416 to indicate a locked state for the HOTO summary or the takeover summary.

On the other hand, if the assessment engine 210 determines that the HOTO summary or the takeover summary is not allowed after submission of the operation shift report, the determination engine 212 may not allow the HOTO summary or the takeover summary to be submitted. In such a situation, the determination engine 212 may transmit to the client device 102-1, a failure indication for the HOTO activity or the self-takeover activity.

In another example, when the assessment engine 210 determines the operation shift report to be in a non-submitted state, the determination engine 212 may not allow the submission of the HOTO summary or the takeover summary. In the example, the communication engine 208 may transmit an indication for submission of the operation shift report to the client device 102-1. In the example, the determination engine 212 may allow submission of the HOTO summary or the takeover summary along with the operation shift report. The determination engine 212 may then store the HOTO summary or the takeover summary in the determination data 418.

Once the HOTO summary or the takeover summary has been received, the determination engine 212 may lock the HOTO summary or the takeover summary for preventing re-submission of HOTO summaries or takeover summaries corresponding to further instances of the HOTO activity or the self-takeover activity. In the example, the determination engine 212 may also mark a flag against the HOTO summary and the takeover summary stored in the assessment data 416 to indicate a locked state for the HOTO summary or the takeover summary.

In an example, the determination engine 212 may store, in the determination data 418, HOTO summaries and takeover summaries corresponding to a plurality of operation shifts. In the example, the determination engine 212 may analyse the HOTO summaries and the takeover summaries to generate a training dataset. In operation, to generate the training dataset, the determination engine 212 may first analyse the HOTO summaries and the takeover summaries based on an unsupervised machine learning model to form various data clusters. Examples of the unsupervised machine learning model that may be utilized to form the data clusters may include, but are not limited to, K-means clustering, KNN (k-nearest neighbors), Hierarchal clustering, Anomaly detection, Neural Networks, Principle Component Analysis, Independent Component Analysis, Apriori algorithm, and Singular value decomposition. In an example, the data clusters may then be analysed and classified to mark the HOTO activities and the self-takeover activities corresponding to the HOTO summaries and the takeover summaries as efficient or inefficient. In an example, the data clusters may be analysed and classified to mark the HOTO activity or the self-takeover activity as efficient or inefficient based on the policies prescribed by the organisation where the HOTO activity or self-takeover activity is being performed.

The determination engine 212 may then train a supervised machine learning model based on the training dataset to classify subsequent HOTO activities and the self-takeover activities as efficient or inefficient. Examples of the supervised machine learning model that may utilized for classification of the subsequent HOTO activities and the self-takeover activities include, but are not limited to, logistic regression, decision tree, random forest, support vector machine, K-Nearest Neighbour (KNN), and Naive Bayes.

In an example, the determination engine 212 may utilize the machine learning model to classify the HOTO summary corresponding to the operation shift as one of efficient or inefficient.

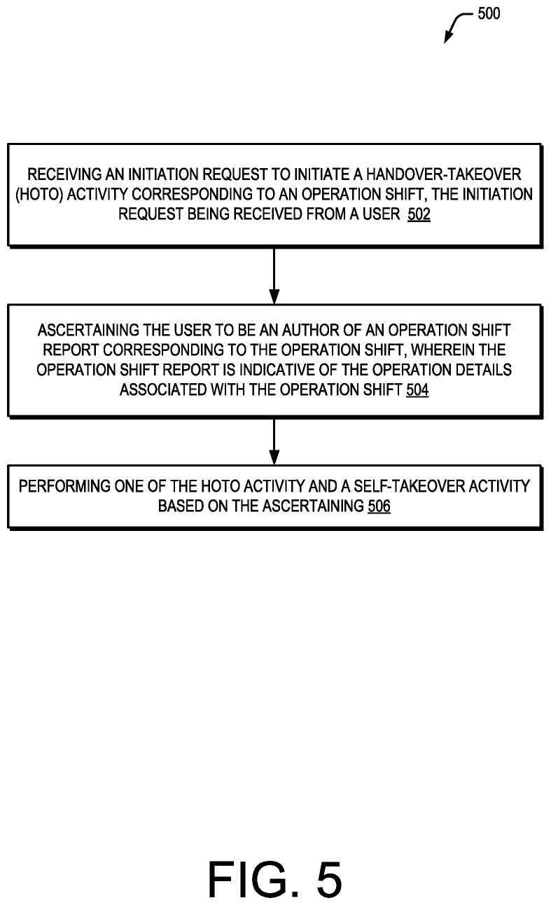

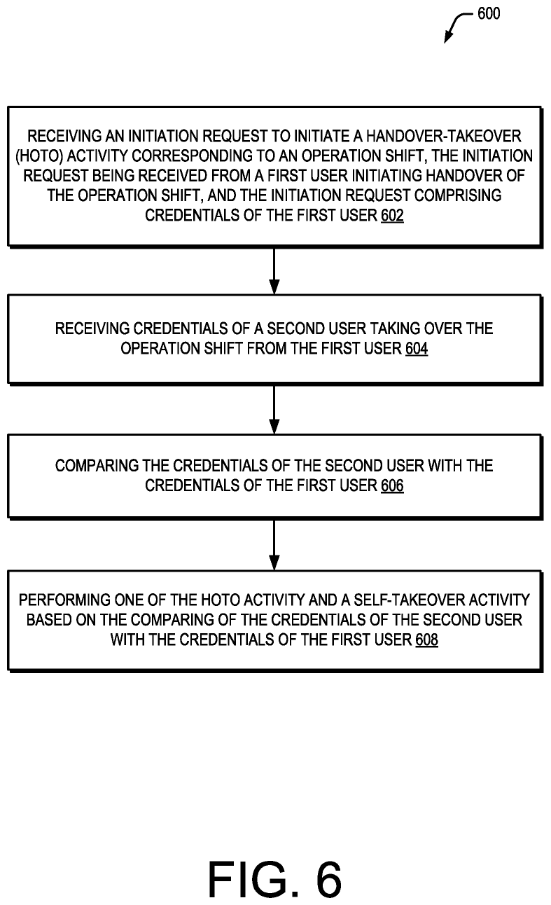

FIG. 5 and FIG. 6 illustrate methods 500 and 600 for performing the HOTO activity corresponding to the operation shift, in accordance with examples of the present subject matter. The order in which the method is described is not intended to be construed as a limitation, and any number of the described method blocks may be combined in any order to implement the methods, or an alternative method. Further, the methods 500 and 600 may be implemented by processing resource or computing device(s) through any suitable hardware, non-transitory machine-readable instructions, or combination thereof.

It may also be understood that methods 500 and 600 may be performed by programmed computing device, such as the client device 102-1, as depicted in FIG. 1, FIG. 2, and FIG. 3. Furthermore, the methods 500 and 600 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 500 and 600 is described below with reference to the client device 102-1, as described above; other suitable systems for the execution of these methods may also be utilized. Additionally, implementation of the method is not limited to such examples.

In FIG. 5, at block 502, an initiation request to initiate a Handover-Takeover (HOTO) activity corresponding to an operation shift may be received. The initiation request may be received from a user, such as a first user 104-1, from the plurality of users 104. Further, the initiation request may include credentials of the first user 104-1. In an example, the initiation request may be received from an interaction engine 202 of the client device 102-1.

At block 504, the first user may be ascertained to be an author of an operation shift report corresponding to the operation shift, where the operation shift report is indicative of the operation details associated with the operation shift. In an example, the operation shift report may be tagged with credentials of a user who provided the operational details during the operation shift. For instance, if the operational details are provided by the first user 104-1, the operation shift report may be tagged with the credentials of the first user 104-1. In the example, the first user 104-1 may be ascertained to be the author of the operation shift report based on a comparison of the credentials of the first user 104-1 with the credentials tagged with the operation shift report. The first user may be ascertained to be the author of the operation shift report by an analysis engine 204 of the client device 102-1.

At block 506, based on ascertaining the first user to be the author of the operation shift report, one of the HOTO activity and a self-takeover activity may be performed. For instance, when the first user 104-1 is ascertained to be the author of the operation shift report, the HOT activity may be performed. On the other hand, when it is ascertained that the first user isn't the author of the operation shift report, the self-takeover activity may be performed. In an example, one of the HOTO activity and a self-takeover activity may be performed by a decision engine 206 of the client device 102-1.

In FIG. 6, at block 602, an initiation request to initiate a Handover-Takeover (HOTO) activity corresponding to an operation shift may be received. The initiation request may be received from a first user initiating handover of the operation shift. Further, the initiation request may include credentials of the first user. In an example, the initiation request to initiate the HOTO activity corresponding to an operation shift may be received by the interaction engine 202 of the client device 102-1.

At block 604, credentials of a second user taking over the operation shift from the first user may be received. The second user may then be authenticated based on the validation of the credentials of the second user. In an example, the credentials of the second user may also be received by the interaction engine 202.

At block 606, the credentials of the second user may be compared with the credentials of the first user. In an example, the credentials of the second user may be compared with the credentials of the first user by an analysis engine 204 of the client device 102-1.

At block 608, one of the HOTO activity and a self-takeover activity may be performed. The one of the HOTO activity and the self-takeover activity may be performed based on the comparing of the credentials of the second user with the credentials of the first user. In an example, when the credentials of the second user are determined to be different from the credentials of the first user, the HOTO activity may be performed. On the other hand, when the credentials of the second user are determined to be same as the credentials of the first user, the self-takeover activity may be performed. In an example, the HOTO activity or the self-takeover activity may be performed by a decision engine 206 of the client device 102-1.

Selectively performing the HOTO activity in scenarios when the operation shift is being handed over from one user to another user facilitates optimization in utilization of resources involved in recording the time consumed in performing the HOTO activity and submission of the HOTO information, thereby improving the overall efficiency involved in performing the HOTO activity.

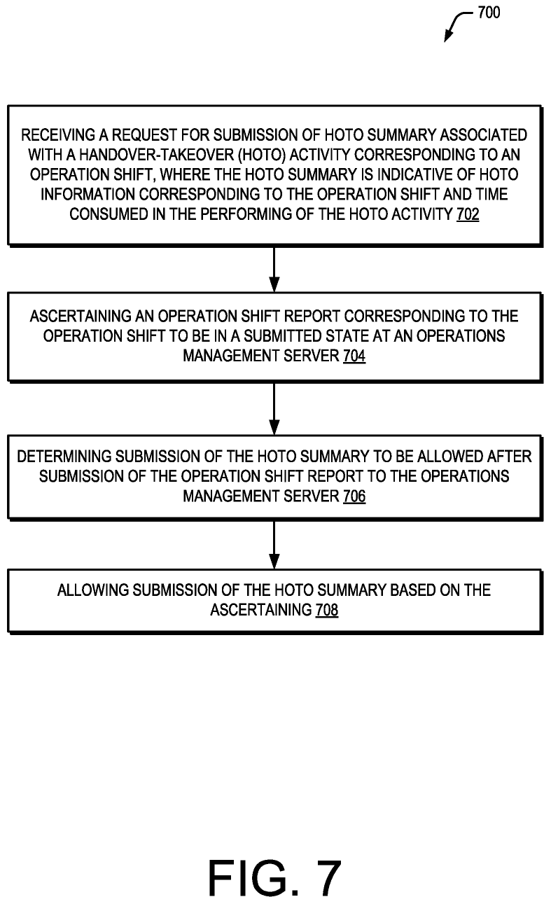

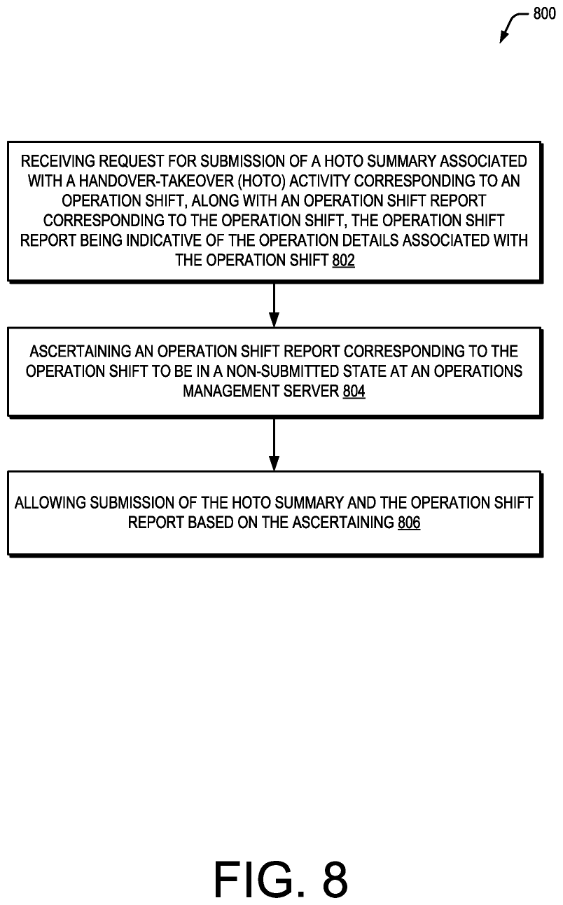

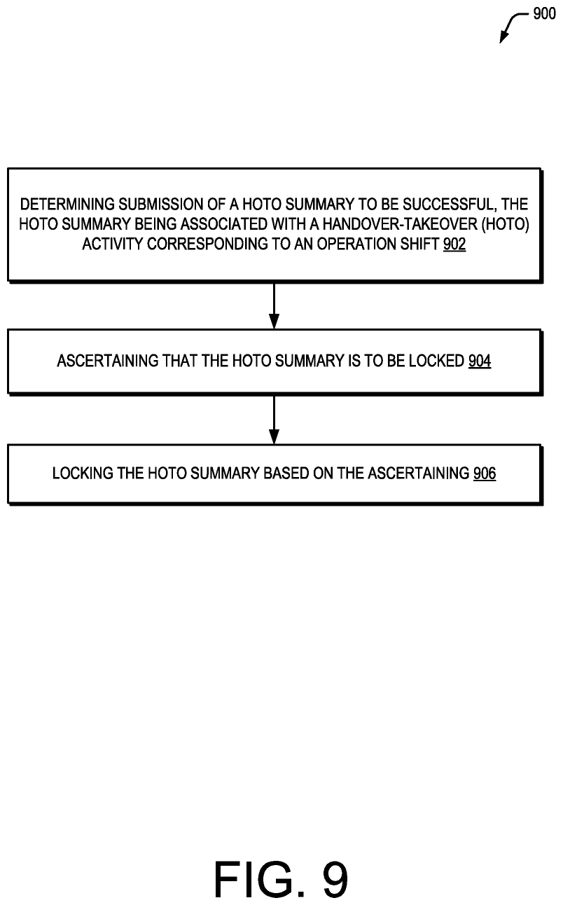

FIG. 7, FIG. 8, and FIG. 9 illustrate methods 700, 800, and 900 for facilitating performing of the HOTO activity corresponding to the operation shift, in accordance with examples of the present subject matter. The order in which the method is described is not intended to be construed as a limitation, and any number of the described method blocks may be combined in any order to implement the methods, or an alternative method. Further, the methods 700, 800, and 900 may be implemented by processing resource or computing device(s) through any suitable hardware, non-transitory machine-readable instructions, or combination thereof.

It may also be understood that methods 700, 800, and 900 may be performed by programmed computing device, such as the operations management server 106 depicted in FIG. 1, FIG. 2, and FIG. 4. Furthermore, the methods 700, 800, and 900 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 700, 800, and 900 is described below with reference to the operations management server 106, as described above; other suitable systems for the execution of these methods may also be utilized. Additionally, implementation of the method is not limited to such examples.

In FIG. 7, at block 702, a request for submission of HOTO summary associated with a Handover-Takeover (HOTO) activity corresponding to an operation shift may be received. The HOTO summary may be indicative of HOTO information corresponding to the operation shift and time consumed in the performing of the HOTO activity. In an example, the request for submission of the HOTO summary may be received by a communication engine 208 of the operations management server 106.

At block 704, an operation shift report corresponding to the operation shift may be ascertained to be in a submitted state at an operations management server. In an example, the operation shift report may be determined to be in the submitted state by an assessment engine 210 of the operations management server 106.

At block 706, it may be determined that the submission of the HOTO summary is allowed after submission of the operation shift report to the operations management server. The submission of the HOTO summary to be allowed after submission of the operation shift report may be determined based on policies prescribed by an organisation where the HOTO activity is being performed. The policies may be prescribed based on various factors. For instance, in an example, the policies may be prescribed based on an overlap time between arrival of the second user 104-2 and departure of the first user 104-1 while the HOTO activity is being performed. If the nature of activities being performed at a facility entails a shorter overlap time, the organisation may require the first user 104-1 to submit the operation shift report before initiation of the HOTO activity. In such a situation, the submission of the HOTO summary may be allowed after submission of the operation shift report. In an example, the submission of the HOTO summary to be allowed after submission of the operation shift report may be determined by the assessment engine 210.

At block 708, based on the determining, submission of the HOTO summary may be allowed. In an example, the submission of the HOTO summary may be allowed by a determination engine 212 of the operations management server 106.

In FIG. 8, at block 802, a request for submission of a HOTO summary associated with a Handover-Takeover (HOTO) activity corresponding to an operation shift may be received. The request may be received along with an operation shift report corresponding to the operation shift, where the operation shift report may be indicative of the operation details associated with the operation shift. In an example, the request for submission of the HOTO summary may be received by a communication engine 208 of the operations management server 106.

At block 804, an operation shift report corresponding to the operation shift may be ascertained to be in a non-submitted state at an operations management server. In an example, the operation shift report corresponding to the operation shift may be ascertained to be in the non-submitted state by an assessment engine 210 of the operations management server 106.

At block 806, submission of the HOTO summary and the operation shift report may be allowed based on the ascertaining. In an example, the submission of the HOTO summary may be allowed by a determination engine 212 of the operations management server 106.

In FIG. 9, at block 902, submission of a HOTO summary may be determined to be successful, where the HOTO summary is associated with a Handover-Takeover (HOTO) activity corresponding to an operation shift. In an example, the submission of the HOTO summary may be determined to be successful by an assessment engine 210 of the operations management server 106.

At block 904, it may be determined that the HOTO summary is to be locked. The HOTO summary may have to be locked for preventing submission of HOTO summaries corresponding to further instances of the HOTO activity. The fact that the HOTO summary is to be locked may be determined based on policies prescribed by an organisation where the HOTO activity is being performed. In an example, the fact that the HOTO summary is to be locked may be determined by the assessment engine 210 of the operations management server 106.

At block 906, based on the ascertaining, the HOTO summary may be locked. In an example, the HOTO summary may be locked by a determination engine 212 of the operations management server 106.

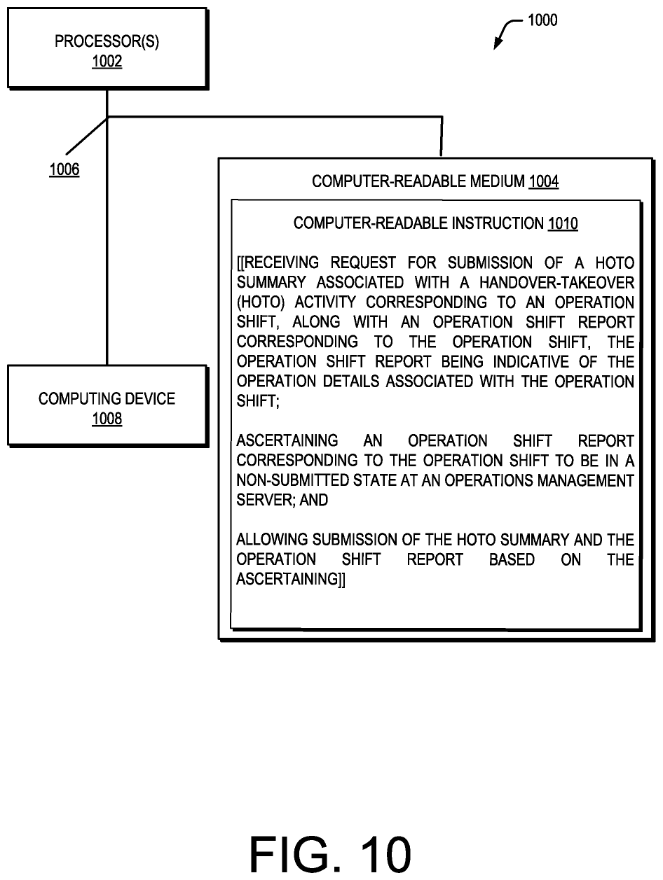

FIG. 10 illustrates illustrates a non-transitory computer-readable medium for facilitating performing of the HOTO activity corresponding to the operation shift, in accordance with an example of the present subject matter.

In an example, the computing environment 1000 includes processor 1002 communicatively coupled to a non-transitory computer readable medium 1004 through communication link 1006. In an example implementation, the computing environment 1000 may be for example, the operations management server 106. In an example, the processor 1002 may have one or more processing resources for fetching and executing computer-readable instructions from the non-transitory computer readable medium 1004. The processor 1002 and the non-transitory computer readable medium 1004 may be implemented, for example, in the operations management server 106.

The non-transitory computer readable medium 1004 may be, for example, an internal memory device or an external memory. In an example implementation, the communication link 1006 may be a network communication link, or other communication links, such as a PCI (Peripheral component interconnect) Express, USB-C (Universal Serial Bus Type-C) interfaces, I²C (Inter-Integrated Circuit) interfaces, etc. In an example implementation, the non-transitory computer readable medium 1004 includes a set of computer readable instructions 1010 which may be accessed by the processor 1002 through the communication link 1006 and subsequently executed for facilitating performing of the HOTO activity corresponding to the operation shift. The processor(s) 1002 and the non-transitory computer readable medium 1004 may also be communicatively coupled to a computing device 1008 over the network.

Referring to FIG. 10, in an example, the non-transitory computer readable medium 1004 includes computer readable instructions 1010 that cause the processor 1002 to receive request for submission of a HOTO summary associated with a Handover-Takeover (HOTO) activity corresponding to an operation shift. The request for submission of a HOTO summary may be received along with an operation shift report corresponding to the operation shift. In an example, the operation shift report may be indicative of the operation details associated with the operation shift.

The instructions 1010 may further cause the processor 1002 to ascertain an operation shift report corresponding to the operation shift to be in a non-submitted state at an operations management server. Further, the instructions 1010 may cause the processor 1002 to allow submission of the HOTO summary and the operation shift report based on the ascertaining.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method comprising:
receiving an initiation request to initiate a Handover-Takeover (HOTO) activity corresponding to an operation shift, the initiation request being received from a first user initiating handover of the operation shift, and the initiation request comprising credentials of the first user;
receiving credentials of a second user taking over the operation shift from the first user;
comparing the credentials of the second user with the credentials of the first user;
performing one of the HOTO activity and a self-takeover activity based on the comparing of the credentials of the second user with the credentials of the first user.

2. The method as claimed in claim 1 further comprising:
determining the second user to be different from the first user based on the comparing of the credentials of the second user with the credentials of the first user; and
performing the HOTO activity based on the determining, wherein the HOTO activity is for the handover of the operation shift from the first user to the second user.

3. The method as claimed in claim 2, wherein the performing of the HOTO activity comprises:
initiating a HOTO timer based on determining the second user to be different from the first user;
receiving, from the first user, HOTO information corresponding to the operation shift; and
stopping the HOTO timer upon receiving a completion request to stop the HOTO activity, the completion request being received from the first user.

4. The method as claimed in claim 3, generating a HOTO summary corresponding to the operation shift, wherein the HOTO summary is indicative of the HOTO information and time consumed in the performing of the HOTO activity.

5. The method as claimed in claim 3 comprising transmitting an operation shift report corresponding to the operation shift to an operations management server, wherein the operation shift report is prepared by the first user, and wherein the operation shift report is indicative of operation details associated with the operation shift.

6. The method as claimed in claim 3 further comprising transmitting the HOTO summary to an operations management server.

7. The method as claimed in claim 3 comprising transmitting the HOTO summary along with an operation shift report corresponding to the operation shift to an operations management server, wherein the operation shift report is prepared by the first user, and wherein the operation shift report is indicative of operation details associated with the operation shift.

8. The method as claimed in claim 3, further comprising:
determining the HOTO summary to be in a submitted state at the operations management server; and
transmitting, to the operations management server, an indication for locking the HOTO summary for preventing editing of the handover report.

9. The method as claimed in claim 1, further comprising:
determining the second user and the first user to be same based on the comparing of the credentials of the second user with the credentials of the first user; and
performing the self-takeover activity based on the determining, wherein the self-takeover activity is for takeover of the operation shift by the first user.

10. The method as claimed in claim 9, further comprising:
receiving, from the first user, takeover information corresponding to the operation shift; and
generating a self-takeover summary corresponding to the operation shift, wherein the self-takeover summary is indicative of the takeover information.

11. The method as claimed in claim 1, comprising authenticating the second user based on validation of the credentials of the second user.

12. The method as claimed in claim 1, comprising:
analysing HOTO summaries corresponding to a plurality of operation shifts for generating a training dataset, wherein the analysing comprises classifying HOTO activities corresponding to the HOTO summaries as one of efficient and inefficient based on the analysing; and
training a machine learning model based on the training dataset to classify HOTO activities as one of efficient and inefficient.

13. The method as claimed in claim 12, further comprising utilizing the machine learning model to classify the HOTO summary corresponding to the operation shift as one of efficient or inefficient.

14. An operations management server comprising:
a communication engine to receive a request for submission of HOTO summary associated with a Handover-Takeover (HOTO) activity corresponding to an operation shift, wherein the HOTO summary is indicative of HOTO information corresponding to the operation shift and time consumed in performing of the HOTO activity;
an assessment engine coupled to the communication engine to:
ascertain an operation shift report corresponding to the operation shift to be in a submitted state at an operations management server; and
determine submission of the HOTO summary to be allowed after submission of the operation shift report to the operations management server; and
a determination engine coupled to the assessment engine to allow submission of the HOTO summary based on the determining.

15. The operations management server as claimed in claim 14, wherein to determine submission of the HOTO summary to be allowed after submission of the operation shift report, the assessment engine is to determine the HOTO activity being to be a first instance of the HOTO activity.

16. The operations management server as claimed in claim 15, further comprising locking the HOTO summary for preventing submission of HOTO summaries corresponding to further instances of the HOTO activity.

17. The operations management server as claimed in claim 14, wherein the determination engine is to:
analyse HOTO summaries corresponding to a plurality of operation shifts for generating a training dataset, wherein the analysing comprises classifying HOTO activities corresponding to the HOTO summaries as one of efficient and inefficient based on the analysing; and
train a machine learning model based on the training dataset to classify HOTO activities as one of efficient and inefficient.

18. The operations management server as claimed in claim 17, wherein the determination engine is to further utilize the machine learning model to classify the HOTO summary corresponding to the operation shift as one of efficient or inefficient.

19. A non-transitory computer readable medium comprising computer-readable instructions that when executed cause a processing resource of a computing device to:
receive request for submission of a HOTO summary associated with a Handover-Takeover (HOTO) activity corresponding to an operation shift, along with an operation shift report corresponding to the operation shift, the operation shift report being indicative of operation details associated with the operation shift;
ascertain an operation shift report corresponding to the operation shift to be in a non-submitted state at an operations management server; and
allow submission of the HOTO summary and the operation shift report based on the ascertaining.

20. The non-transitory computer-readable medium as claimed in claim 19, wherein the instructions cause the processing resource to lock the HOTO summary and the operation shift report for preventing submission of HOTO summaries and the operation shift reports corresponding to further instances of the HOTO activity.
